(19) United States
(12) Patent Application Publication
(10) Pub. No.: US 2007/0070917 A1
(43) Pub. Date: Mar. 29, 2007

(54) Method for installing a backup power source in a service access interface

(75) Inventors: Arvind R. Mallya, Walnut Creek, CA (US); David L. Kimble, Danville, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/234,018

(22) Filed: Sep. 23, 2005

(51) Int. Cl. H04L 12/28

(52) U.S. Cl. 370/254

(57) ABSTRACT

A system and method are disclosed for installing a backup power source (200) in a service access interface, also known as a cross-connect interface (CCI) (110). A system that incorporates teachings of the present disclosure may include, for example, a method having the steps of searching (306) for topology information of a selected CCI coupled to a central office for distributing telecommunication services to one or more buildings, and identifying (310-318) according to said topology information a backup power source capable of supporting a load requirement of the CCI.

### FIELD OF THE DISCLOSURE

The present disclosure relates generally to backup power systems in telecommunication networks, and more specifically to a method for installing a backup power source in a service access interface.

### BACKGROUND

As broadband services such as high definition TV (HDTV), voice over IP (VoIP), and high speed data links expand to residences, telecommunication service providers are expected to incorporate new communication technologies in service access interfaces. Service access interfaces, also known as cross-connect interfaces (CCIs), distribute telecommunication services originating at a central office to residences, commercial enterprises, and so on.

A need therefore arises for a method to properly install these new technologies in the CCIs.

### BRIEF DESCRIPTION OF THE DRAWINGS

FIG. 1 is a block diagram of power and communication cabling between a central office (CO) and a cross-connect interface (CCI) according to teachings of the present disclosure;

FIG. 2 depicts a flowchart of a method operating in a network management system (NMS) associated with the CO according to teachings of the present disclosure;

FIG. 3 depicts a backup power source in the CCI according to teachings of the present disclosure; and

FIG. 4 is a diagrammatic representation of a machine in the form of a computer system within which a set of instructions, when executed, may cause the machine to perform any one or more of the methodologies discussed herein.

### DETAILED DESCRIPTION

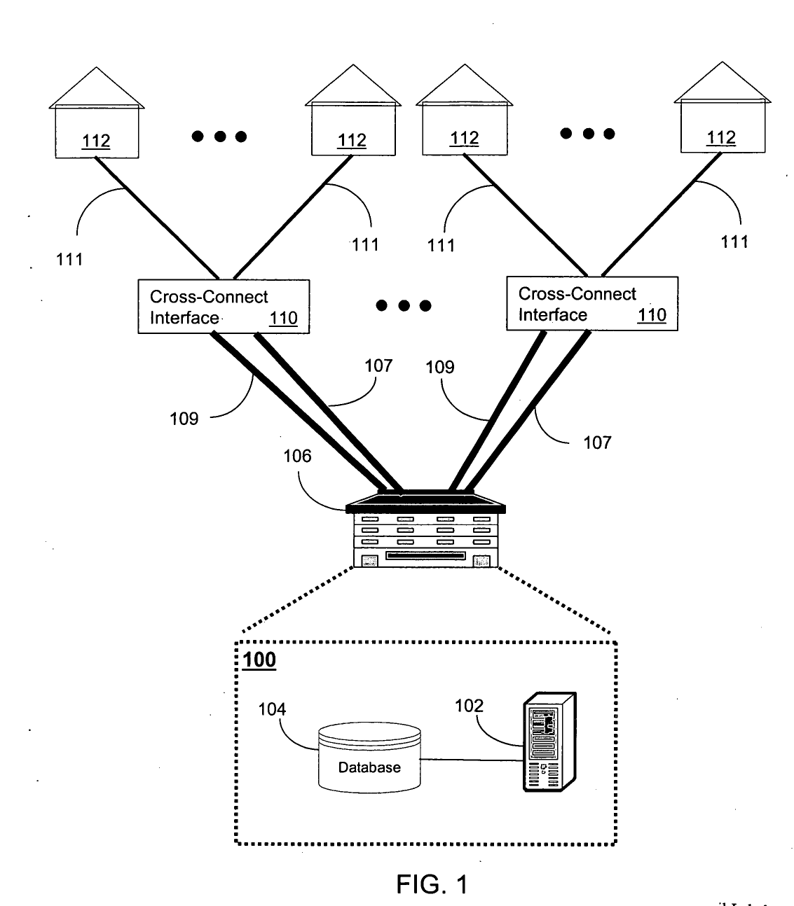

FIG. 1 is a block diagram of power and communication cabling between a central office (CO) 106 and a cross-connect interface (CCI) 110 according to teachings of the present disclosure. The CO 106 can distribute telecommunication services by way of the CCI 110 to buildings 112 such as residences or commercial enterprises. For illustration purposes only, buildings 112 will herein be referred to as residences 112. Telecommunication services of the CO 106 can include traditional POTS (Plain Old Telephone Service) and broadband services such as HDTV, VoIP (Voice over Internet communications, IPTV (Internet Protocol Television), Internet services, and so on. To support broadband services, the CCI 110 includes active circuits such as an optical interface for translating optical signals originating from the CO 106 on fiber links 109 to electrical signals distributed on, for example, twisted copper pairs 111 to residences 108.

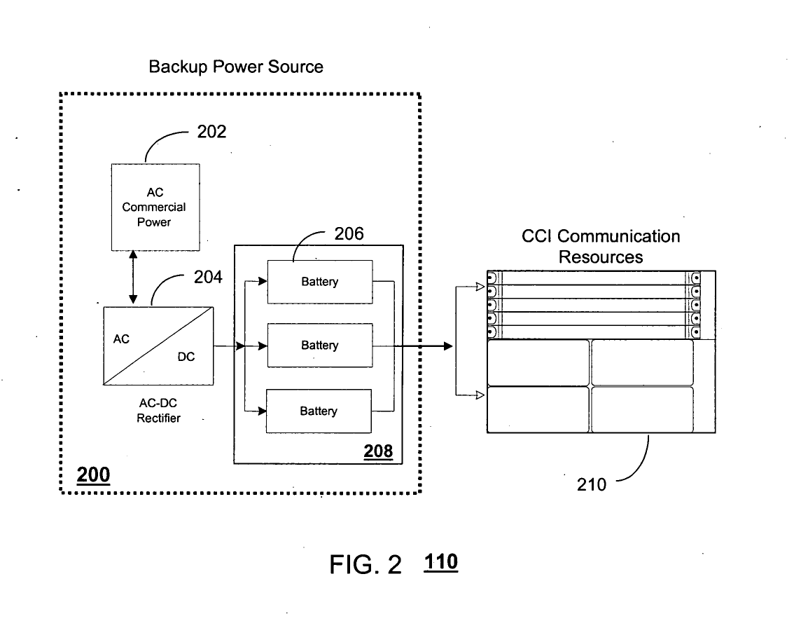

Links 107 can be twisted copper pairs for distributing power to the CCIs 110 throughout a region such as a city or metropolitan area. Alternatively, links 107 can be coupled to local commercial power near the CCIs 110 supplied by, for example, a utility company. When there is a power outage, the foregoing services are continued in whole or in part by way of a backup power source 200. The backup power source 200 can comprise an AC-DC rectifier 204, battery banks 206, and an CCI communication resources shelf 210 as shown in FIG. 2. The AC-DC rectifier 204 can be coupled to an AC commercial power source 202 such as provided by a utility company. In lieu of this power source configuration, a DC-DC rectifier coupled to links 107 of the CO 106 can be utilized. In either embodiment, the battery banks 206 are charged by the rectifier 204 thereby performing the function of an uninterrupted power source (UPS) 208 for the CCI communication resources shelf 210, which can include, for example, optical-to-electrical communication devices, telemetry equipment, and so on. The type of rectifier 204 and UPS 208 configuration appropriate for each CCI 110 deployed by a telecommunications provider can be determined by a network management system (NMS) 100 associated with the CO 106.

The NMS 100 can comprise a controller 102 and a memory 104. The controller 102 utilizes common computing technology such as a desktop computer or scalable server. The memory 104 can be a mass storage medium such as a high-density disk drive for managing, for example, a database that maintains topologies of interconnects between the CO 106 and the CCIs 110, and the CCIs 110 and residences 112. It would be apparent to an artisan with ordinary skill in the art that one or more NMS 100 can be used to manage installation of a backup power source 200 for CCIs 110 coupled to one or more COs 106. Thus FIG. 1 provides a single instance of an embodiment of the NMS 100, which should not be construed as limiting the scope of the present disclosure.

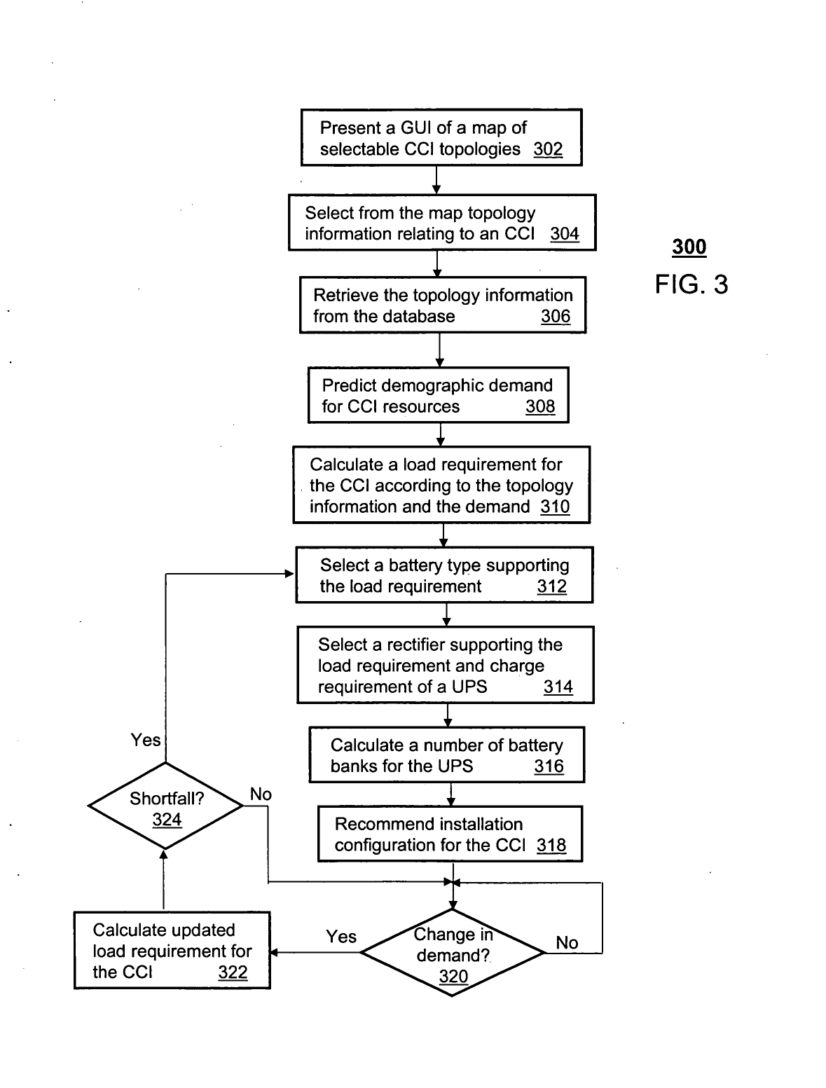

FIG. 3 depicts a flowchart of a method 300 operating in the NMS 100 according to teachings of the present disclosure. Method 300 begins with step 302 whereby service personnel of the CO 106 can be presented with a GUI (Graphical User Interface) of a map of selectable CCI topologies. From this step service personnel can select from the map in step 304 corresponding topology information of an CCI 110. In step 306, the controller 102 retrieves the topology information from its database 104. The topology information retrieved includes relevant information useful in determining an appropriate backup power source for the CCI 110. For example, the topology information can include information relating to the active communication equipment in the CCI 110 shelf and the power load required for each, the communication components that may be needed to upgrade the CCI for broadband communications (and other services) and the expected load requirement of this equipment, the load requirement of existing residences coupled to the CCI 110, resistive loading and thermal loss data for power and communication cables in the CCI, and so on.

The NMS 100 can be programmed to monitor and predict in step 308 demographic demand for CCI resources. The NMS 100 can for instance monitor a CRM (Customer Relations Management) database from its own memory 104 or from an independent system coupled thereto, which is periodically updated according to consumer demand by agents or an IVR (Interactive Voice Response) system of the telecommunications provider. The NMS 100 alternatively or in addition thereto can monitor marketing systems that analyze regional demographics and/or psychographic data thereby providing the NMS 100 a means to utilize common techniques for modeling communication resource demand for the CCIs 110. From these predictions and the topology information discussed above, the NMS 100 can calculate in step 310 a load requirement for the selected CCI 110 in the form of any useful unit of energy such as Joules, or Watts.

Using common power management techniques, the NMS 100 selects in step 312 a battery type 206 having conductance capable of supporting the load requirement determined in step 310. Similarly, the NMS 100 selects in step 314 a rectifier 204 capable of supporting the load requirement and charge requirement of one or more batteries of a UPS system such as shown in FIG. 2. From these selections, the NMS 100 utilizes common techniques to calculate in step 316 a number of battery banks for the UPS 208. The aforementioned configuration is then presented graphically and/or textually as a recommendation to the service personnel of the CO 106 in step 318.

To avoid a future shortage in backup power capacity, the NMS 100 can be programmed to monitor and detect in step 320 a predicted change in the demographic demand for CCI communication resources. If no change is detected in step 320, the monitoring process continues. If a meaningful change is predicted calling to question the capacity of the backup power source 200, the NMS 100 proceeds to step 322 where it calculates an updated load requirement for the CCI 110 according to the predicted change in demand and the topology information of the CCI 110 existing at the time of the detection. In step 324, the NMS 100 determines whether there would be a shortfall in the capacity of the rectifier 204, the UPS 208 or both. If not, then the NMS 100 continues to monitor for changes in step 320. If a shortfall is detected, then the NMS 100 proceeds to steps 312 through 318 where it determines and recommends a change in the rectifier 204, the UPS 208, or both. This latter embodiment provides a proactive means to maintain a desirable quality of service without interruption to consumers. Steps 320 through 324 can operate as a background process once a backup power source 200 is installed in an CCI 110.

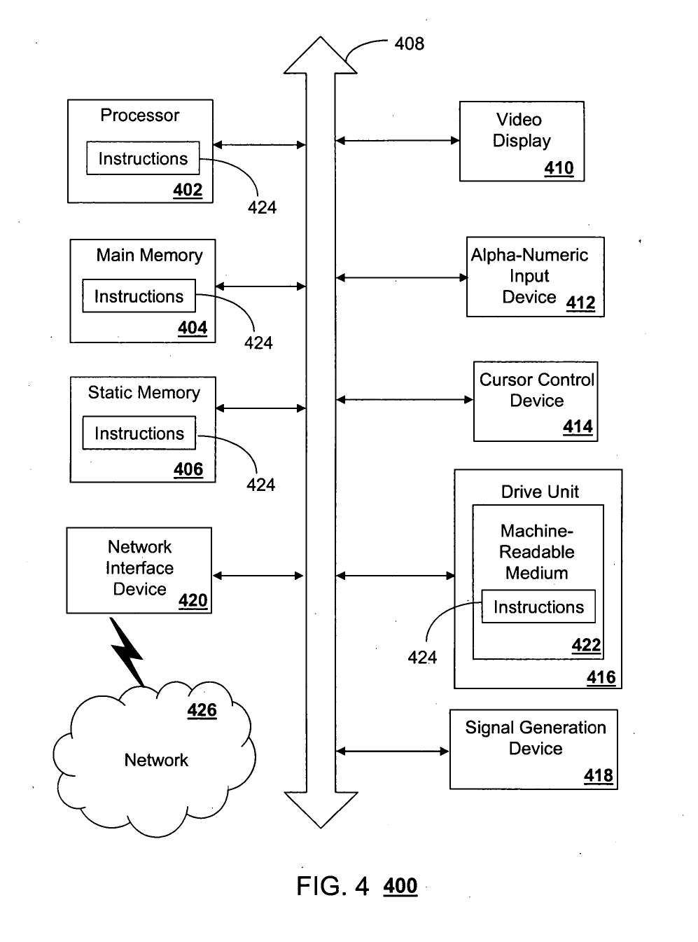

FIG. 4 is a diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising the steps of:
searching topology information of a cross-connect interface (CCI) that distributes telecommunication services to one or more buildings; and
identifying according to said topology information a backup power source capable of supporting a load requirement of the CCI.

2. The method of claim 1, comprising the steps of:
calculating the load requirement for the CCI according to the topology information;
selecting a battery type having a conductance capable of supporting the load requirement;
selecting a rectifier capable of supporting the load requirement and charge requirement of one or more batteries; and
calculating a number of battery banks for an uninterrupted power supply (UPS) to support the load requirement of the CCI during a power outage for a desired period of time.

3. The method of claim 2, comprising the step of selecting as a function of temperature the rectifier and the battery type.

4. The method of claim 2, comprising the step of selecting as a function of mean time between failures (MTBF) the rectifier and the battery type.

5. The method of claim 2, comprising the steps of:
predicting a change in demographic demand for resources distributed by the CCI to consumers; and
repeating the foregoing steps according to the change in demographic demand.

6. The method of claim 2, comprising the step of calculating a cost increase in the CCI according to a cost of the rectifier, a cost of power supplied locally to the CCI, and a cost of the UPS.

7. The method of claim 1, comprising the steps of:
predicting a demand for resources distributed by the CCI to consumers; and
calculating the load requirement for the CCI according to the demand and the topology information;
selecting a battery having a conductance capable of supporting the load requirement;
selecting a rectifier capable of supporting the load requirement and charge requirement of one or more batteries;
calculating a number of battery banks for a UPS to support the load requirement of the CCI during a power outage for a desired period of time.

8. The method of claim 1, comprising the step of installing in the CCI the backup power source, wherein the backup power sources comprises a rectifier and a bank of batteries of a UPS capable of supporting the load requirement of the CCI during a power outage for a desired period of time.

9. A computer-readable storage medium, comprising computer instructions for:
searching topology information of a selected CCI coupled to a central office for distributing telecommunication services to one or more buildings; and
identifying according to said topology information an uninterrupted power source (UPS) capable of supporting a load requirement of the CCI as a function of at least one among a group of operating conditions comprising a desired temperature and mean time between failures (MTBF).

10. The storage medium of claim 9, comprising computer instructions for:
calculating the load requirement of the CCI according to a predicted demographic demand and the topology information;
selecting a battery type having a conductance capable of supporting the load requirement,
selecting a rectifier capable of supporting the load requirement and charge requirement of one or more batteries; and
calculating a number of battery banks for the UPS to support the load requirement of the CCI during a power outage for a desired period of time.

11. The storage medium of claim 10, comprising computer instructions for calculating a total cost of the CCI according to a cost of the rectifier, a cost of power supplied locally to the CCI, a cost of the UPS, and a cost of communication resources in the CCI.

12. The storage medium of claim 9, comprising computer instructions for:
monitoring demographic demand for CCI communication resources;
predicting a change in demand;
calculating an updated load requirement of the CCI according to the predicted change in demand and the topology information;
detecting a shortfall in capacity of the UPS; and
updating the UPS according to the predicted change in demand.

13. A network management system (NMS), comprising:
a controller, programmed to:
present a GUI (Graphical User Interface) of a map of selectable CCI topologies;
select from said map topology information of a CCI that distributes telecommunication services to one or more buildings; and
identify according to said topology information a rectifier and an uninterrupted power source (UPS) capable of supporting a load requirement of the CCI.

14. The NMS of claim 13, wherein the controller is programmed to:
calculate the load requirement for the CCI according to the topology information;
select a battery type having a conductance capable of supporting the load requirement;
select a rectifier capable of supporting the load requirement and charge requirement of one or more batteries;
calculate a number of battery banks for the UPS to support the load requirement of the CCI for a desired period of time; and
recommend an installation configuration for the CCI.

15. The NMS of claim 13, wherein the controller is programmed to calculate the load requirement for the CCI according to a predicted demographic demand for resources distributed by the CCI.

16. The NMS of claim 13, wherein the controller is programmed to:
monitor demographic demand for resources distributed by the CCI;
predict an increase in demand for said resources;
calculate an updated load requirement for the CCI according to said increase in demand and the topology information;
determine whether the rectifier and the UPS can support the updated load requirement.

17. The NMS of claim 16, wherein the controller is programmed to alert a service provider of the CCI when detecting that at least one among the rectifier and the UPS cannot support the updated load requirement.

18. The NMS of claim 16, wherein the controller is programmed to:
detect a shortfall in the capacity of one among the rectifier and the UPS to support the updated load requirement; and
select at least one among a new battery bank for the UPS capable of supporting the updated load requirement, and a new rectifier capable of supporting the updated load requirement and charge requirement of the UPS.

19. The NMS of claim 18, wherein the controller is programmed to calculate a cost increase in the CCI according to at least one among the new rectifier and the new UPS.

20. The NMS of claim 13, wherein the controller is programmed to:
select the rectifier and the UPS as a function of the load requirement of the CCI and at least one among ambient temperature of the CCI and a desired MTBF; and
calculate a total cost of the CCI according to a cost of the rectifier, a cost of power supplied locally to the CCI, a cost of the UIPS, and a cost of communication resources in the CCI.
